(19) United States
(12) Patent Application Publication
(10) Pub. No.: US 2015/0371308 A1
(43) Pub. Date: Dec. 24, 2015

(54) CUSTOMIZABLE GREETING CARDS

(71) Applicant: Timothy Beresnyak, Jersey City, NJ (US)

(72) Inventor: Timothy Beresnyak, Jersey City, NJ (US)

(21) Appl. No.: 14/308,356

(22) Filed: Jun. 18, 2014

(51) Int. Cl. G06Q 30/06; H04L 29/08

(52) U.S. Cl. CPC G06Q 30/0621; H04L 67/02

(57) ABSTRACT

The present invention includes a system for creating greeting cards. A webpage may be produced by a web server having access to a database. A user may select at least one template greeting card from a plurality of template greeting cards that are stored on the database. The user may then enter custom data that will appear on the greeting card. The entered data is receive and saved in the database. The user may then send a link to access a complete printable greeting card and/or a downloadable complete printable greeting card. The complete printable greeting card includes a merge of the entered data and the selected template greeting card.

### BACKGROUND OF THE INVENTION

The present invention relates to greeting cards and, more particularly, to customizable greeting cards.

A greeting card is an illustrated, folded card featuring an expression of friendship or other sentiment. Although greeting cards are usually given on special occasions such as birthdays and holidays, they are also sent to convey thanks or express other feeling. Websites using special personalization technology allow consumers to personalize a card which is then printed and sent directly to the recipient. However, current systems require software to be downloaded by a customer to customize their greeting cards, taking up space on the user's hard drive.

As can be seen, there is a need for improved web sites offering customizable greeting cards.

### SUMMARY OF THE INVENTION

In one aspect of the present invention, a system for creating greeting cards, comprises: a computer having a user interface; and a program product comprising machine-readable program code for causing, when executed, the computer to perform the following process steps: producing a webpage using a web server having access to a database; prompting a user to select at least one template greeting card from a plurality of template greeting cards stored in the database; prompting the user to enter data; receiving and saving an entered data on the database; and sending to at least one of the user and a third party recipient at least one of a link to access a complete printable greeting card and a downloadable complete printable greeting card, wherein the complete printable greeting card comprises a merge of the entered data and the selected template greeting card.

In another aspect of the present invention, a method of forming a greeting card comprising: providing access to a plurality of template greeting cards via a website, wherein the plurality of template greeting cards are stored in a database; prompting a user to select a template greeting card from the plurality of template greeting cards; entering customized data into an input display on the website; sending to at least one of the user and a third party recipient access to a complete printable greeting card via email, wherein the complete printable greeting card comprises a merge of the entered customized data and the selected template greeting card.

These and other features, aspects and advantages of the present invention will become better understood with reference to the following drawings, description and claims.

### BRIEF DESCRIPTION OF THE DRAWINGS

FIG. 1 is a screenshot of the homepage of the website of the present invention;

FIG. 2 is a screenshot of an example template greeting card;

FIG. 3 is a screenshot of an example prompt screen for the user to enter customizable data;

FIG. 4 is a screenshot of an example prompt screen for the user to enter customizable data;

FIG. 5 is a flow chart of an embodiment of the present invention; and

FIG. 6A-6C are plan views of the completed printed greeting card and illustrating a method of folding the printed greeting card.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a website for creating online greeting cards. Using an online shopping cart allows a consumer to email a personalized printable greeting card. Using product attributes as input fields, the fields are merged directly to a card when printed. Data may be entered directly to the product page and saved on a remote database, where as other methods require a user to download a third party software to their browser. By allowing the customer to input data directly to the product page of a shopping cart, the present invention eliminates the need to for the customer to download software. A website, web server and database may be used to store data and host the PDF (printable digital format), PDFtk™ may be used to merge the data to a PDF, a shopping cart with text fields may be used to capture data and send an email to the customer.

In certain embodiments, a user may design a graphic design and save it to a PDF. The PDF may have fields for custom data. Each field may include a machine readable name. Once uploaded onto a web server the user may create a product in a shopping card which allows each of the custom fields to be input fields as product attributes. When the customer fills in the data it is stored in the database and called later by the PDFtk™ function. A dynamic link may be produced and emailed to the email provided in one of the custom fields as well as to the customer who purchased the product. The card may be sent as an attachment via email or a dynamic link in the provided email calls the PDFtk™ merge function on the server, merges the fields into a PDF which the customer can download and print as a greeting card.

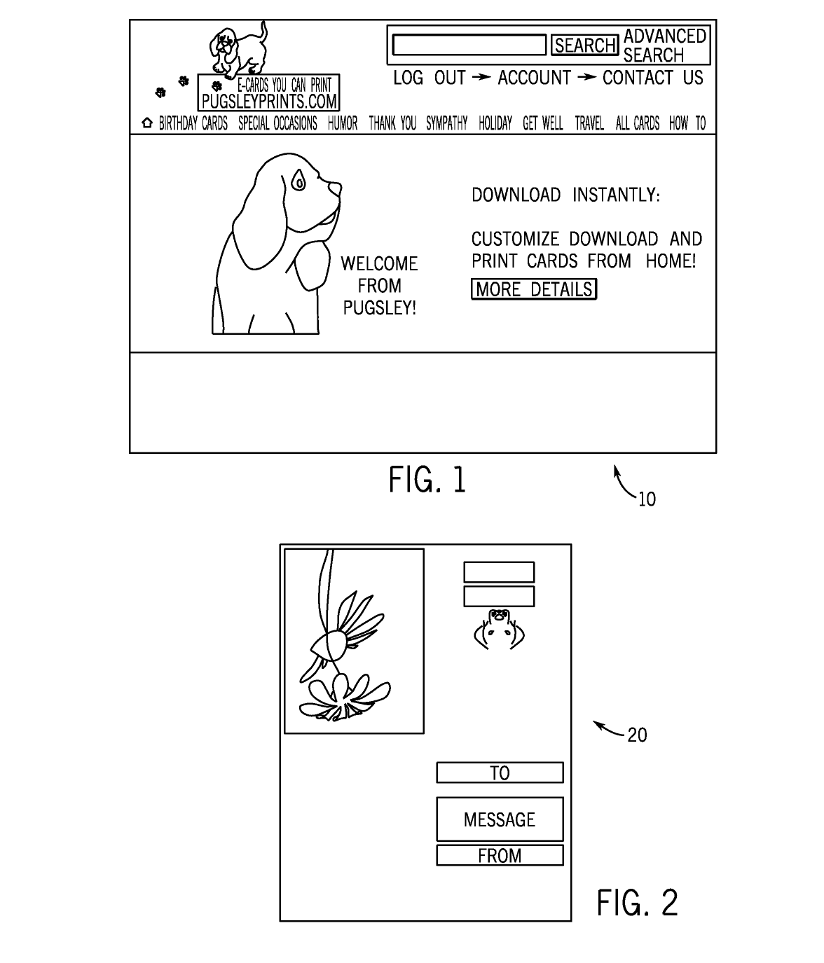

Referring to FIGS. 1 through 6, the present invention includes a system for creating greeting cards 60. The system may include a computer having a user interface and a program product having machine-readable program code for causing the computer to perform steps. A webpage 10 may be produced by a web server having access to a database. A user may select at least one template greeting card 20 from a plurality of template greeting cards 20 that are stored on the database. The user may then enter custom data that will appear on the greeting card 60. The entered data is saved in the database. The user may then send a link to access a complete printable greeting card 60 and/or a downloadable complete printable greeting card 60. The complete printable greeting card 60 includes a merge of the entered data and the selected template greeting card 20.

FIGS. 1 and 2 illustrate a screenshot of the webpage 10 and a sample of a template greeting card 20. The webpage 10 may allow a user to navigate through and choose the template greeting card 20 that is desired. As illustrated, the website 10 may display different categories of template greeting cards 20 for the user to choose from. In certain embodiments, the user may sign into the website by creating a username and password, allowing the user to select cards and save them so the card may be customized and purchased at a later date.

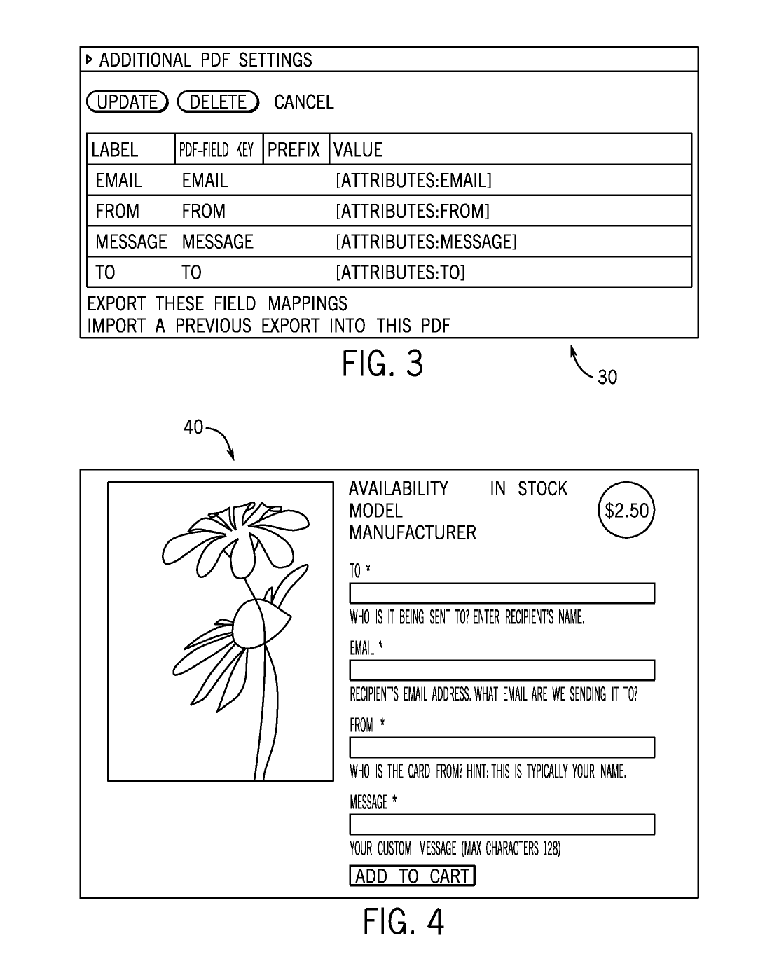

FIGS. 3 and 4 demonstrate how the user may customize the template greeting card 20. Once the template greeting card 20 has been selected, the user is prompted to input customized data, such as text. The website 10 may display an input screen 30, 40 for the user to enter the data. In certain embodiments, the website 10 may prompt the user to enter a third party recipient's name, a third party recipient's email address, the user's name, and/or a custom message. Once the user has entered the data, the entered data and the selected template greeting card 20 may be merged to become the complete printable greeting card 60.

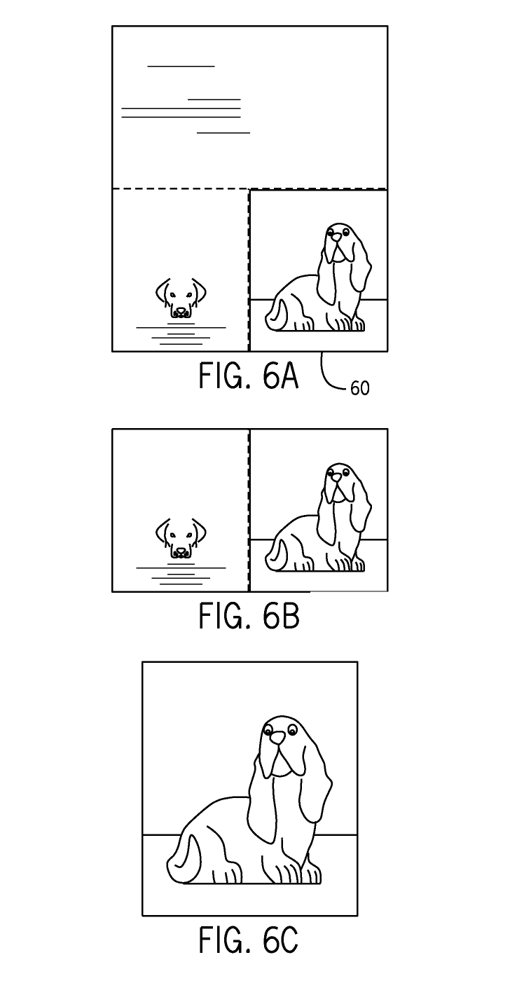

In certain embodiments, the link to access the completed card 60 may be sent to the email of the third party recipient and/or the user. The third party recipient and/or the user may activate the link to access the complete printable greeting card 60. In certain embodiments, the activation of the link prompts the merging of the entered data and the selected template greeting card 20 creating the complete printable greeting card 60. The completed printable greeting card 60 is displayed to the recipient, and the recipient may download the greeting card and print the complete printable greeting card 60. As illustrated in FIG. 6A-6C, printable greeting card 60 may be printed with folding lines, in which the user and/or third party may fold to create the complete card.

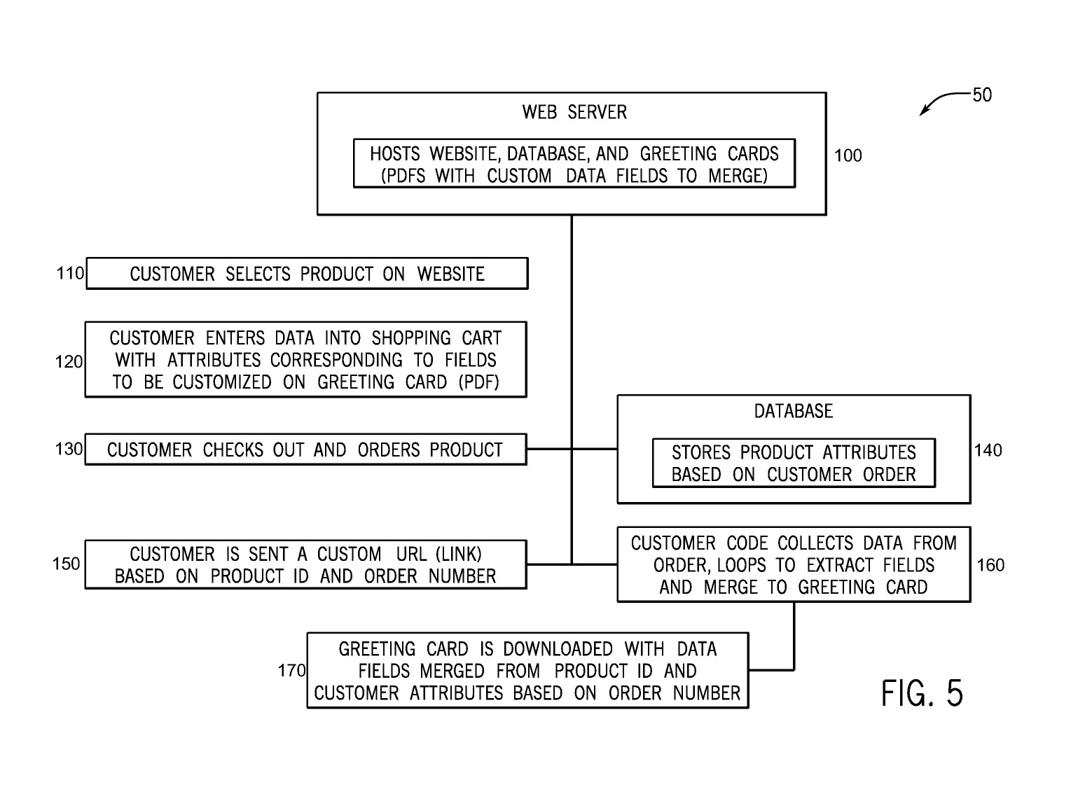

The flowchart 50 of FIG. 5 illustrates the steps taken to perform the present invention. As mentioned above, a web server may host the website database and the stored greetings card 100. The customer (user) may select the template greeting card on the website 110. The customer may enter the data into the “shopping cart” with attributes corresponding to fields to be customized on the greeting card 120. The customer may check out and order the product 130. The entered data and the template card selected are stored on the database 140. The customer may be sent a custom URL (link) based on the product ID and order number 150. The customer code collects data from the order and merges the entered data and the greeting card 160. The completed greetings card is downloaded either by the third party user or the customer 170.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for creating greeting cards, comprising:
a computer having a user interface; and
a program product comprising machine-readable program code for causing, when executed, the computer to perform the following process steps:
producing a webpage using a web server having access to a database;
prompting a user to select at least one template greeting card from a plurality of template greeting cards stored in the database;
prompting the user to enter data;
receiving and saving an entered data on the database; and
sending to at least one of the user and a third party recipient at least one of a link to access a complete printable greeting card and a downloadable complete printable greeting card, wherein the complete printable greeting card comprises a merge of the entered data and the selected template greeting card.

2. The system of claim 1, wherein the entered data comprises at least one of a third party recipient's name, a third party recipient's email address, the user's name, and a custom message.

3. The system of claim 1, wherein the computer further performs the following process step: merging the entered data and the selected template greeting card creating the complete printable greeting card.

4. The system of claim 1, wherein the at least one link to access the complete printable greeting card and the downloadable complete printable greeting card is sent to the third party recipient's email address.

5. The system of claim 1, wherein the computer performs the following process steps:
prompting the third party recipient to activate the link to access the complete printable greeting card, wherein the activation of the link prompts the merging of the entered data and the selected template greeting card creating the complete printable greeting card;
displaying the complete printable greeting card to the third party; and
prompting the user to at least one of download the complete printable greeting card to the third party's computer and print the complete printable greeting card.

6. A method of forming a greeting card comprising:
providing access to a plurality of template greeting cards via a website, wherein the plurality of template greeting cards are stored in a database;
prompting a user to select a template greeting card from the plurality of template greeting cards;
entering customized data into an input display on the website;
sending to at least one of the user and a third party recipient access to a complete printable greeting card via email, wherein the complete printable greeting card comprises a merge of the entered customized data and the selected template greeting card.

7. The method of claim 6, wherein the access to the complete printable greeting card is in the form of a link.

8. The method of claim 7, wherein the entered customized data and the selected template greeting card are merged once the link has been activated.

9. The method of claim 6, wherein the entered customized data comprises at least one of a third party recipient's name, a third party recipient's email address, the user's name, and a custom message.

10. The method of claim 6, further comprising printing out the complete printable greeting card on paper and folding the paper to form a complete printed greeting card.
